(19) United States
(12) Patent Application Publication
(10) Pub. No.: US 2022/0197090 A1
(43) Pub. Date: Jun. 23, 2022

(54) BACKLIGHT UNITS HAVING QUANTUM DOTS

(71) Applicant: CORNING INCORPORATED, CORNING, NY (US)

(72) Inventors: Songfeng Han, Shanghai (CN); Dmitri Vladislavovich Kuksenkov, Elmira, NY (US); Shenping Li, Painted Post, NY (US); Xiang-Dong Mi, Pittsford, NY (US)

(21) Appl. No.: 17/606,156

(22) PCT Filed: Apr. 23, 2020
(86) PCT No.: PCT/US2020/029486

§ 371 Date: Oct. 25, 2021

Related U.S. Application Data
(60) Provisional application No. 62/896,818, filed on Sep. 6, 2019.
(60) Provisional application No. 62/840,693, filed on Apr. 30, 2019.

(51) Int. Cl. G02F 1/1335; F21V 8/00; G02F 1/13357

(52) U.S. Cl. CPC G02F 1/133614; G02F 1/133605; G02B 6/0055

(57) ABSTRACT

Novel backlighting units (BLU) for use with LCD panel are disclosed. Such BLUs have direct lighting configuration utilizing blue LED as light source and have quantum dots (QDs) integrated into the architecture of the BLU thus forming thin BLUs that efficiently convert the blue source light into white light while achieving enhanced uniformity in brightness of the white light.

### CROSS-REFERENCE TO RELATED APPLICATION

This application claims the benefit of priority under 35 U.S.C. § 119 of U.S. Provisional Application Ser. No. 62/896,818 filed on Sep. 6, 2019 and U.S. Provisional Application Ser. No. 62/840,693 filed on Apr. 30, 2019, the contents of each of which are relied upon and incorporated herein by reference in their entireties.

### FIELD

The present disclosure relates to backlight units for liquid crystal displays, and particularly to backlight units that incorporate quantum dots.

### BACKGROUND

Liquid crystal display (LCD) industry is seeking solutions that improve the efficiency of LCDs and improve their color gamut (the color content of the display), in order to be competitive with organic light emitting display (OLED) products. Traditional LCDs lag behind OLEDs particularly in the color gamut performance. The use of quantum dots (QDs) in LCDs has improved the color gamut performance of LCDs. Such improvements are visible in LCD designs where QD film elements are used in the backlighting units (BLUs), the light source that provides light that gets passed through an active matrix of liquid crystal (LC) filled pixels of the LCD pixelated panel. In these BLU designs, blue LED light is coupled to a light guiding plate (LGP) along the edges of the LGP. The blue light is then extracted from the LGP in the direction towards the LCD pixelated panel. The guided blue light then encounters QDs which absorb a portion of the blue light and emits light in green and red spectrum. The resulting light in red, green, and blue spectrum provides a white light source from the BLU for the LCD pixelated panel. However, because the blue LED light source pumps light into the LGP from the edges, the number of LEDs that can be placed along the edge is limited and the overall brightness of the backlighting is limited. Direct-lit BLU configuration improved the brightness of the backlighting by allowing greater number of LEDs to be utilized by providing an array of LEDs behind the LGP. The drawback of the conventional direct-lit BLUs, however, is that they are much thicker than the edge-lit configuration.

Therefore, improved BLU configuration is desired.

### SUMMARY

Novel backlighting units (BLU) for use with LCD panel are disclosed. Such BLUs comprise direct lighting configuration utilizing blue LED as light source and comprise quantum dots (QDs) integrated into the architecture of the BLU thus forming thin BLUs that efficiently convert the blue source light into white light while achieving enhanced uniformity in brightness of the white light.

According to an embodiment of the present disclosure, a direct lit BLU is disclosed in which a blue light source is provided over the LGP and QDs are incorporated into the top reflector layer and/or the light extraction features on the LGP. The light extraction features can be formed over the top side or the bottom side of the LGP.

In some embodiments of the BLU, QDs are incorporated over the bottom surface of the LGP. In some embodiments of the BLU, QDs are incorporated over the printed circuit board that functionally supports the blue LED light source.

In some embodiments of the BLU, QDs are incorporated over the top surface of the LGP and the LGP includes a patterned reflective surface feature.

In some embodiments of the BLU, QDs are incorporated over the top surface of the LGP and also includes a patterned optical clear adhesive layer between the LGP and the QD material layer.

In some embodiments of the BLU, QDs are incorporated over the bottom surface of the LGP and also includes a patterned optical clear adhesive layer between the LGP and the QD material layer.

In some embodiments of the BLU, QDs are incorporated over the top surface of the LGP that includes a patterned reflective surface feature and also includes a patterned optical clear adhesive layer between the LGP and the QD material layer.

In some embodiments of the BLU, QDs are incorporated over the bottom surface of the LGP that includes a patterned reflective surface feature and also includes a patterned optical clear adhesive layer between the LGP and the QD material layer.

It is to be understood that both the foregoing general description and the following detailed description present embodiments of the present disclosure, and are intended to provide an overview or framework for understanding the nature and character of the claimed subject matter. The accompanying drawings are included to provide a further understanding of the present disclosure, and are incorporated into and constitute a part of this specification. The drawings illustrate various embodiments and together with the description serve to explain the principles and operations of the claimed subject matter.

### BRIEF DESCRIPTION OF THE DRAWINGS

These figures are provided for the purposes of illustration, it being understood that the embodiments disclosed and discussed herein are not limited to the arrangements and instrumentalities shown.

FIGS. 1 and 2 show illustrations of an architecture of a direct lit BLU according to an embodiment of the present disclosure in which QDs are incorporated into the top reflector and/or the light extraction features.

FIG. 2A shows a detailed view of the area A denoted in FIG. 2.

FIG. 3 shows an illustration of an architecture of a direct lit BLU according to an embodiment of the present disclosure in which QDs are incorporated into the first major (the top) surface of the LGP and light extraction features are formed over the second major (the bottom) surface of the LGP.

FIG. 4 shows an illustration of an architecture of a direct lit BLU according to an embodiment of the present disclosure in which QDs and light extraction features are formed over the top surface of the LGP.

FIG. 5 shows an illustration of an architecture of a direct lit BLU according to an embodiment of the present disclosure in which QDs are incorporated over the bottom surface of the LGP.

FIG. 6 shows an illustration of an architecture of a direct lit BLU according to an embodiment of the present disclosure in which QDs are incorporated over the printed circuit board (PCB) that supports the blue LED light source.

FIG. 7 shows an illustration of an architecture of a direct lit BLU according to an embodiment of the present disclosure in which QDs are incorporated over the top surface of the LGP and the LGP includes a patterned reflective surface feature.

FIG. 8 shows an illustration of an architecture of a direct lit BLU according to an embodiment of the present disclosure in which QDs are incorporated over the top surface of the LGP and also includes a patterned optical clear adhesive layer between the LGP and the QD material layer.

FIG. 9 shows an illustration of an architecture of a direct lit BLU according to an embodiment of the present disclosure in which QDs are incorporated over the bottom surface of the LGP and also includes a patterned optical clear adhesive layer between the LGP and the QD material layer.

FIG. 10 shows an illustration of an architecture of a direct lit BLU according to an embodiment of the present disclosure in which QDs are incorporated over the top surface of the LGP that includes a patterned reflective surface feature and also includes a patterned optical clear adhesive layer between the LGP and the QD material layer.

FIG. 11 shows an illustration of an architecture of a direct lit BLU according to an embodiment of the present disclosure in which QDs are incorporated over the bottom surface of the LGP that includes a patterned reflective surface feature and also includes a patterned optical clear adhesive layer between the LGP and the QD material layer.

FIG. 12A is a schematic illustration of an arrangement of emissive elements in an emissive display and their relationship to image pixels in the emissive display.

FIG. 12B is a schematic sectional view of a region of an emissive display that is within one pitch of an emissive element.

FIG. 13 is a top view illustration of the segmented perforated MC-PET film according to the present disclosure.

While this description can include specifics, these should not be construed as limitations on the scope, but rather as descriptions of features that can be specific to particular embodiments.

### DETAILED DESCRIPTION

Various embodiments for luminescent coatings and devices are described with reference to the figures, where like elements have been given like numerical designations to facilitate an understanding.

It also is understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, the group can comprise, consist essentially of, or consist of any number of those elements recited, either individually or in combination with each other.

Similarly, whenever a group is described as consisting of at least one of a group of elements or combinations thereof, the group can consist of any number of those elements recited, either individually or in combination with each other. Unless otherwise specified, a range of values, when recited, includes both the upper and lower limits of the range. As used herein, the indefinite articles “a,” and “an,” and the corresponding definite article “the” mean “at least one” or “one or more,” unless otherwise specified

When a layer or some other features are described herein as being formed “over” a receiving surface, the expression “over a surface” encompasses the scenario where the layer or the some other features being directly formed on the receiving surface, such that there is nothing else between the features and the receiving surface, as well as other scenarios where some intervening material(s) can be present between the layer or the some other features and the receiving surface. For example, the intervening material(s) can be one or more intervening layers.

Those skilled in the art will recognize that many changes can be made to the embodiments described while still obtaining the beneficial results of the disclosure. It also will be apparent that some of the desired benefits of the present disclosure can be obtained by selecting some of the described features without using other features. Accordingly, those of ordinary skill in the art will recognize that many modifications and adaptations are possible and can even be desirable in certain circumstances and are part of the disclosure. Thus, the following description is provided as illustrative of the principles of the present disclosure and not in limitation thereof.

Those skilled in the art will appreciate that many modifications to the exemplary embodiments described herein are possible without departing from the spirit and scope of the disclosure. Thus, the description is not intended and should not be construed to be limited to the examples given but should be granted the full breadth of protection afforded by the appended claims and equivalents thereto. In addition, it is possible to use some of the features of the present disclosure without the corresponding use of other features. Accordingly, the foregoing description of exemplary or illustrative embodiments is provided for the purpose of illustrating the principles of the present disclosure and not in limitation thereof and can include modification thereto and permutations thereof

[Quantum Dots]

The quantum dots (QDs) are nano crystals having diameters of about 1 to 10 nm, are formed of a semiconductor material, and cause a quantum confinement effect. The QDs convert wavelengths of light emitted from the light source and generate wavelength-converted light, i.e., fluorescent light.

Examples of the QDs include silicon (Si)-based nano crystals, Group II-VI-based compound semiconductor nano crystals, Group III-V-based compound semiconductor nano crystals, and Group IV-VI-based compound semiconductor nano crystals. According to the current embodiment, the quantum dots may be one or a mixture of the above examples.

In this case, the Group II-VI-based compound semiconductor nano crystals may be formed of one selected from the group consisting of, for example, CdS, CdSe, CdTe, ZnS, ZnSe, ZnTe, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HggZnTe, CdZnSeS, CdZnSeTe, CdZnSTe, CdHgSeS, CdHgSeTe, CdHgSTe, HgZnSeS, HgZnSeTe, and HgZnSTe. The Group III-V-based compound semiconductor nano crystals may be formed of one selected from the group consisting of, for example, GaN, GaP, GaAs, A1N, AlP, AlAs, InN, InP, InAs, GaNP, GaNAs, GaPAs, A1NP, A1NAs, AlPAs, InNP, InNAs, InPAs, GaA1NP, GaA1NAs, GaAlPAs, GaInNP, GaInNAs, GaInPAs, InAlNP, InA1NAs, and InA1PAs. The Group IV-VI-based compound semiconductor nano crystals may be formed of, for example, SbTe.

As described above, the light source can be light emitting devices such as LEDs. Generally, blue LEDs are often used as light sources in BLUs. In preferred embodiments, the light source is a blue LED. Such blue LEDs may emit light having a dominant wavelength of 435 to 470 nm.

When the blue light from the blue LED light source reaches the QDs, the QDs are excited by the blue light and the QDs will emit red light and green light into red light and green light. According to some embodiments, the QDs used in the BLU of the present disclosure comprise two groups. The first group of QDs convert the blue light into light in a wavelength band of red light. The second group of QDs convert the blue light into light in a wavelength band of green light. The wavelength band of the converted light produced by QDs are determined by the shape and size of the QDs. The types of QDs that can be used to generate the desired green light and red light are well known in the industry.

In some embodiments, the sizes of the first and second QDs may be appropriately controlled such that the peak wavelength of the first group of QDs that generate green light is 500 to 550 nm and the peak wavelength of the second group of QDs that generate red light is 580 to 660 nm.

QDs generate more intense light in a narrower wavelength band in comparison to typical phosphor. As such, the green light generating QDs may have a full-width half-maximum (FWHM) of 10 to 60 nm and the red light generating QDs may have an FWHM of 30 to 80 nm. Meanwhile, blue LEDs having an FWHM of 10 to 30 nm are used as the light source.

When QDs for emitting light of different colors are mixed, if the ratio of colors of the QDs varies, a user may view light of different wavelengths. In order to prevent this problem, materials need to be mixed in accurate densities and at an accurate ratio. In mixing the QDs, the light emission efficiency of the QDs has to be considered in addition to the densities.

According to another aspect of the present disclosure, the light source may be a ultraviolet LED and particle size and densities of the QDs utilized in the BLU can be selected to include a first type of QDs having a size for allowing a peak wavelength to be in a wavelength band of blue light, second type of QDs having a size for allowing a peak wavelength to be in a wavelength band of green light, and a third type of QDs having a size for allowing a peak wavelength to be in a wavelength band of red light. Thus, in such embodiments, the QDs convert the ultraviolet light into red, green, and blue light that together produce white light for the BLU.

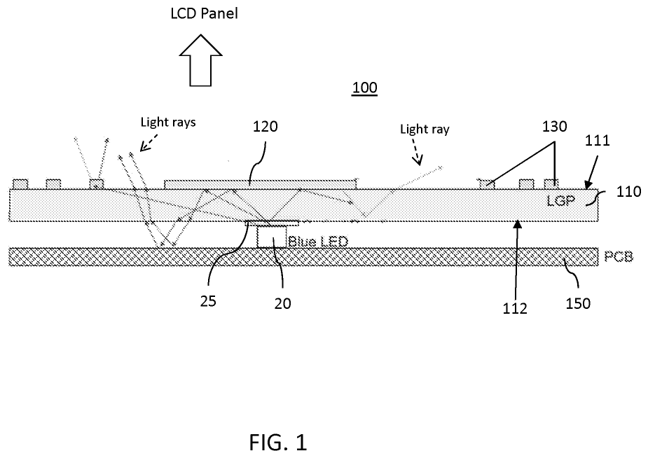

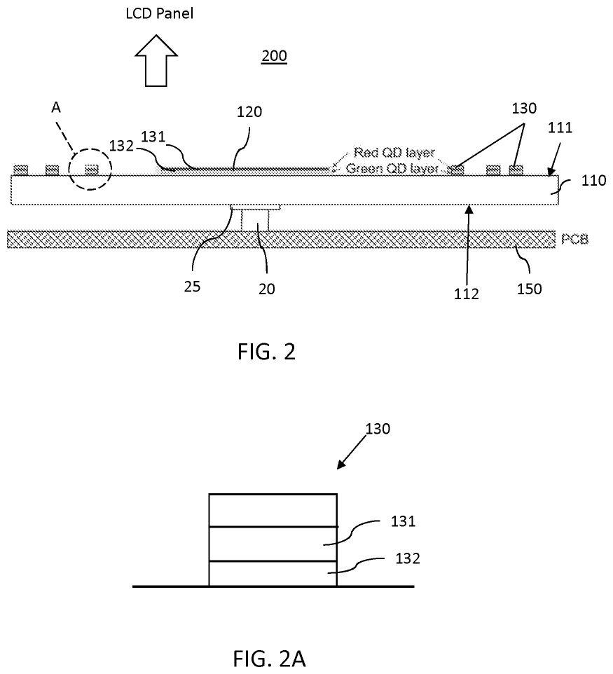

Referring to FIGS. 1 and 2, an embodiment of a BLU 100 having a direct lighting configuration for use with a LCD panel in which QDs are incorporated into a top reflector 120 and/or light extraction features is disclosed. The BLU 100 comprises a light guide plate (LGP) 110 comprising two major surfaces, a first major surface 111 facing in the direction of the LCD panel and a second major surface 112 opposite the first major surface. The LGP 110 can be made of glass.

A light source 20 is provided over the second major surface 112 of the LGP. Preferably, the light source 20 is placed close to the second major surface 112 of the LGP to promote efficient light coupling to the LGP so that the light can diffuse within the LGP and reduce or eliminate hotspots (bright spots). In some embodiments, the light source 20 can be directly optically bonded to the second major surface 112 of the LGP. Directly bonding the light source to the LGP can further improve the transmission of the light into the LGP and be diffused therein. The direct optical bonding can be achieved by optical bonding material 25. The light source 20 is the type selected to emit blue light and can be blue LED.

In some embodiments of the BLU 100, instead of directly bonding the light source to the LGP, the light diffusion and coupling can be improved by other ways such as by roughening the portion of the second major surface 112 of the LGP near the light source; by providing a layer of scattering particles between the light source 20 and the second major surface 112 of the LGP; or providing an optical grating, or some surface features, such as grooves and prisms, on the second major surface 112 of the LGP which faces the light source.

In embodiments where the light source 20 is not directly bonded to the LGP, an air gap can exist between the light source and the LGP. The air gap can be between about 1 μm to about 25% of the LED pitch. Although the accompanying figures for the example BLUs show only one LED light source, BLUs will generally have an array of LEDs as the light source. The LED pitch refers to the center-to-center distance between two adjacent LEDs in the LED array. In some embodiments where a thinner BLU structure is desired, smaller air gap is preferred. The amount of air gap can be controlled to adjust the alignment tolerance between the LED and the LGP to align the LED and the top reflector on the LGP. Increasing the air gap can also increase the luminance, and/or color uniformity of the BLU. The top reflector 120 is described in detail below.

The BLU 100 also includes a top reflector layer 120 formed over the first major surface 111 of the LGP. The top reflector layer 120 is positioned on the first major surface 111 to be opposite from the light source 20. The top reflector layer 120 reflects some of the light from the light source 20 back into the LGP and help diffuse the light so that there are no bright spots in the backlighting provided to the LCD panel. In some embodiments, the top reflector layer 120 is formed directly on the first major surface 111 of the LGP. In some embodiments, a layer of primer can be placed in between the top reflector layer 120 and the first major surface 111 of the LGP. The primer can be an adhesion promoting material.

According to the present disclosure, the top reflector layer 120 comprises QD materials incorporated therein for converting the blue light from the light source 20 to red and green light. The QD materials comprise a red QD material and a green QD material. The red QD material comprises a plurality of red QDs and the green QD material comprises a plurality of green QDs where the red QDs absorb a portion of the blue light from the light source 20 and emit red light and the green QDs absorb a portion of the blue light and emit green light.

Part of the blue light from the light source 20 that is incident on the top reflector layer 120 is converted to green and red light by the QDs in such a proportion that the light reflected back into the LGP is white. The composite of the blue, red, and green lights form white light that gets diffused throughout the LGP, then eventually exit the LGP through the first major surface 111 and travel toward the LCD panel.

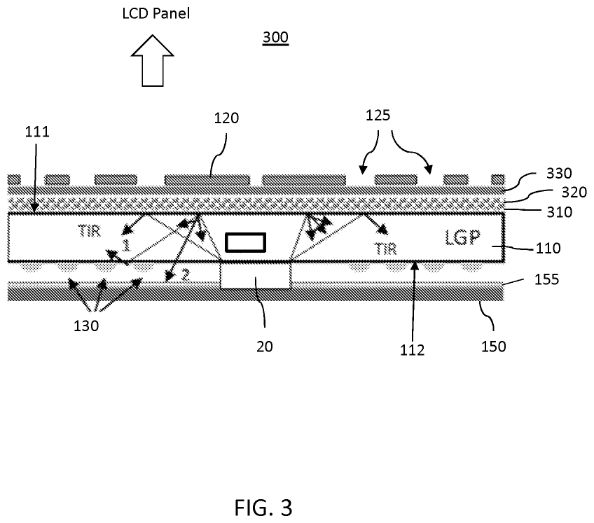

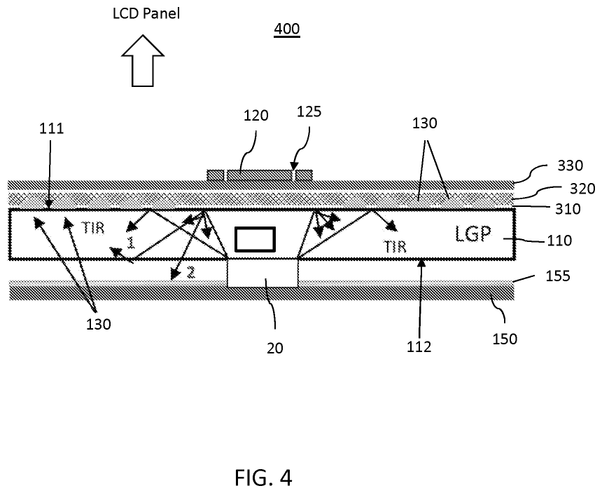

The top reflector layer 120 is generally made of a film that has some transmissivity in addition to reflectivity because if the reflector layer 120 reflected 100% of the light coming from the light source, they will form dark spots in the BLU and cannot deliver uniform backlighting over the full area of the LCD panel. In some embodiments, the top reflector layer 120 can comprise a patterned reflector. The patterned reflector can be coatings or printed surfaces with either variable thickness, or variable surface coverage. Variable surface coverage may indeed look like a continuous coated area with holes in the coating, but could also be a collection of isolated “dots” or “islands” of coating typical of for example inkjet printed patterns, or a combination of isolated dots and continuous areas with holes. The patterned reflector can be integrated into the LGP and does not need to be on the surface of the LGP. In some embodiments, the patterned reflector can comprise a plurality of holes 125 (shown in FIGS. 3 and 4 for example). The holes 125 can allow additional transmission of light. Such patterned top reflector layer can be formed over the LGP surface by printing process.

In some embodiments, the BLU 100 can also comprise a plurality of light extraction features 130 formed over the first major surface 111 of the LGP to enhance extraction of light from the LGP 110 since the purpose of an LGP is not to trap light forever within it but extract it after they are uniformly diffused throughout the LGP. In some embodiments, the plurality of light extraction features can be formed directly on the surface of the LGP. In some embodiments, the plurality of light extraction features can be formed with a layer of primer between the light extraction features and the LGP surface. The primer is an adhesive material to help the light extraction features to adhere to the LGP. The plurality of light extraction features 130 are formed over the first major surface 111 in the areas not occupied by the top reflector layer 120.

Referring to FIG. 2, in some embodiments, the plurality of light extraction features 130 can also comprise the red QD material and the green QD material to provide additional color conversion ability for the BLU 100. The light extraction features are 2D distribution of bumps, holes, or grooves on the surface of the LGP that helps light bouncing around in the LGP by total internal reflection (TIR) effect to exit or be extracted at the interface of the LGP surface and the surrounding. The structure of such light extraction features 130 is well known in the art. Some examples are an array of bumps, grooves, and lenticular structures formed on the surface of the LGP that provide prism-like facets on the surface of the LGP 110.

The QDs in the top reflector layer 120 and the light extraction features 130 can be dispersed as homogenous mixtures of red QDs and green QDs. Preferably, the red and green QDs are provided in different layers or separated into different regions. This minimizes absorption of the converted green light by the red QDs which generates excessive red light. In some embodiments, the red and green QDs are present in the top reflector layer 120 with a (red QDs):(green QDs) ratio in the range from 1:2 to 1:20. Preferably, the red and green QDs are present in the top reflector layer with a (red QDs) : (green QDs) ratio in the range of approximately 1:2 up to 1:20 depending on the particular QD materials used. In some embodiments, the (red QDs) : (green QDs) ratio in the plurality of light extraction features is in the range from 1:2 to 1:20.

By incorporating the QDs into the top reflector layer and/or the light extraction features, the volume of QDs is kept small and the QDs are provided in thin layers. This also minimizes absorption of the converted green light by the red QDs. The QD layer can be as thin as approx. 2 μm in photoresist and up to approx. 20 μm thick.

Referring to FIG. 2, in a BLU 200 according to some embodiments, the red QD material and the green QD material are provided in the top reflector layer 120 as separate layers: red QD layer 131, and green QD layer 132. In some embodiments, the red QD material and the green QD material are provided in the plurality of light extraction features 130 as separate layers: red QD layer 131, and green QD layer 132. FIG. 2A is an illustration of the area A in FIG. 2 more detailed view of one of the light extraction features 130 identifying the red QD layer 131 and the green QD layer 132. In some embodiments, the QD materials in both the top reflector layer 120 and the plurality of light extraction features are provided as separate layers.

In addition to the QDs, the top reflector layer 120 and the light extraction features 130 can also comprise light scattering particles. Light scattering particulates can be incorporated into the top reflector layer material, for example, as the reflector layer is being deposited or printed. The minute particles scattered throughout the top reflector layer and/or the light extraction features can reflect light in all directions thus diffusing the light and help achieve uniform brightness for the BLU.

FIG. 3 shows an illustration of an architecture of a direct lit BLU 300 according to another embodiment of the present disclosure in which QDs are incorporated into the top major surface 111 of the LGP 110 and a plurality of light extraction features 130 are formed over the second major surface 112 of the LGP 110.

In some embodiments, a BLU 300 comprises: a LGP comprising two major surfaces, a first major surface 111 facing in the direction of the LCD panel and a second major surface 112 opposite the first major surface. A light source 20 provided over the second major surface of the LGP and optically bonded to the second major surface 112 of the LGP. The light source emits blue light and preferably a blue LED. A layer of low index material 310 is formed over the first major surface of the LGP. A low index material is generally a highly porous organic or inorganic material, such as for example, aerogel or a hybrid material made of hollow glass particles and a binder. The function of the low index film layer is to preserve the TIR guiding of light in the LGP. In some embodiments, the low index material 310 can be formed directly on the first major surface 111 of the LGP. In some embodiments, a layer of adhesion promoting primer layer can be placed between the low index material layer 310 and the first major surface 111 of the LGP.

A QD material layer 320 is formed over the layer of low index material 310. A barrier layer 330 is formed over the QD material layer; and a top reflector layer 120 is formed over the barrier layer 330, positioned opposite from the light source 20. The barrier layer 330 is a protective layer that protects the QDs from the environment. A separate barrier layer is not needed on the other side of the QD material layer 320 because the glass LGP itself provides an excellent environmental barrier. The QD material layer 320 comprises a plurality of red QDs and a plurality of green QDs that convert the blue light received from the light source 20 into red light and green light.

Referring to FIG. 3, in some embodiments, BLU 300 can also comprise a plurality of light extraction features 130 formed over the second major surface 112 of the LGP 110. The printed circuit board (PCB) 150 on which the LED light source 20 is functionally attached comprises a layer of bottom reflector 155. The bottom reflector 155 reflects the light exiting the LGP back into the LGP so that the light can eventually exit the first major surface 111 of the LGP, go through the QD material layer 320 and toward the LCD panel as white light.

In some embodiments of the BLU 300, a PCB 150 that functionally supports the LED light source 20 is attached to the LED light source from the side of the LED opposite from the light emitting side which is optically bonded to the LGP 110. The PCB 150 comprises a first surface facing the LGP 110, and the LED light source 20 is attached to the first surface of the PCB 150. Therefore, the LED 20 is optically bonded to the LGP on the light emitting side and is physically attached to and functionally supported by the PCB on the opposite side. The PCB 150 functionally supports the LED light source 20 because the PCB supplies the electricity for the LED light source. The PCB 150 also comprises a back-reflection layer 155 formed over its first surface.

Referring to FIG. 4, in the embodiment of BLU 400 shown, the placement of the QD material layer 320 is the same as in the BLI 300. However, in BLU 400, a plurality of light extraction features 130 are formed over the first major surface 111 of the LGP 110 between the QD material layer 320 and the low index material layer 310.

In both embodiments of the BLU 300 and 400, the top reflector layer 120 can comprise a patterned reflector with holes. The patterned top reflector layer and the light extraction features work with other optical films that may be present in the BLU structure to achieve uniform brightness across the full BLU area.

In both embodiments of the BLU 300 and 400, the QD material layer 320 comprises red and green QDs. The red and green QDs are present in the ratios mentioned above. In some embodiments of the BLU 300 and 400, the QD material layer 320 comprises a red QD layer and a green QD layer provided as separate layers.

In some embodiments of the BLU 300 and 400, a PCB 150 that functionally supports the LED light source 20 is attached to the LED light source from the side of the LED opposite from the light emitting side which is optically bonded to the LGP 110. The PCB 150 comprises a first surface facing the LGP 110, and the LED light source 20 is attached to the first surface of the PCB 150. Therefore, the LED 20 is optically bonded to the LGP on the light emitting side and is physically attached to and functionally supported by the PCB on the opposite side. The PCB 150 functionally supports the LED light source 20 because the PCB supplies the electricity for the LED light source. The PCB 150 also comprises a back-reflection layer 155 formed over its first surface.

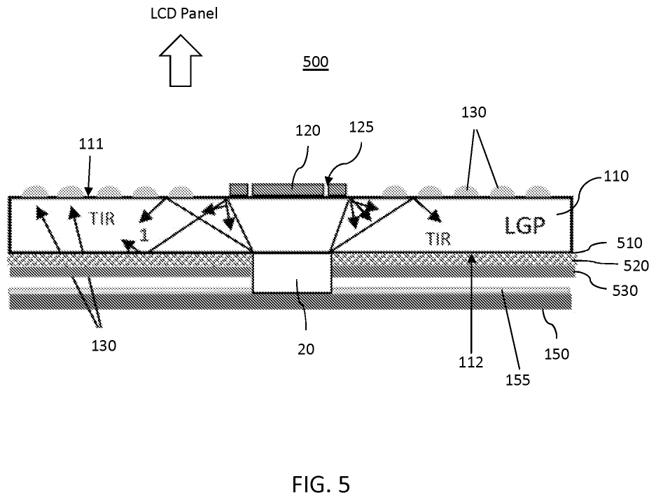

FIG. 5 shows an illustration of an architecture of a directly lit BLU 500 according to an embodiment of the present disclosure in which QDs are incorporated on the bottom side of the LGP 110. “Bottom side” as used herein refers to the side opposite from the LCD panel. The BLU 500 comprises the LGP 110 comprising the first major surface 111 and the second major surface 112 opposite the first major surface 111. As in the other embodiments, a light source 20 is provided over the second major surface 112 of the LGP and is optically bonded to the second major surface 112 of the LGP 110. The light source 20 emits blue light.

The BLU 500 also comprises the top reflector layer 120 formed over the first major surface 111 of the LGP, positioned opposite from the light source 20. A plurality of light extraction features 130 are also formed over the first major surface 111 of the LGP in areas not occupied by the top reflector layer 120. A layer of low index material 510 is formed over the second major surface 112 of the LGP. A QD material layer 520 is formed over the layer of low index material 510. A barrier layer 530 is formed over the QD material layer 520. As described in connection with the QD material layers in other embodiments above, the QD material layer 520 comprises a plurality of red QDs and a plurality of green QDs that absorb a portion of the blue light from the light source and emit red and green light.

In this embodiment of BLU 500, because the low index material layer 510, the QD material layer 520, and the barrier layer 530 are all fabricated on the second major surface of the LGP 110, because the LED light source 20 needs to be optically bonded (i.e., directly bonded) to the LGP for the proper functioning of the BLU, the low index material layer 510 cannot be continuous and needs to have breaks or openings therein for the LED/LGP bonding area.

The top reflector layer 120 can comprise a patterned reflector with a plurality of holes, as in the other BLU embodiments discussed above. In the BLU 500, the red and green QDs are present in the ratios described above. In some embodiments of the BLU 500, the QD material layer can comprise a red QD layer and a green QD layer formed as separate layers.

In some embodiments of the BLU 500, a PCB 150 that functionally supports the LED light source 20 is attached to the LED light source from the side of the LED opposite from the light emitting side which is optically bonded to the LGP 110. The PCB 150 comprises a first surface facing the LGP 110, and the LED light source 20 is attached to the first surface of the PCB 150. Therefore, the LED 20 is optically bonded to the LGP on the light emitting side and is physically attached to and functionally supported by the PCB on the opposite side. The PCB 150 functionally supports the LED light source 20 because the PCB supplies the electricity for the LED light source. The PCB 150 also comprises a back-reflection layer 155 formed over its first surface.

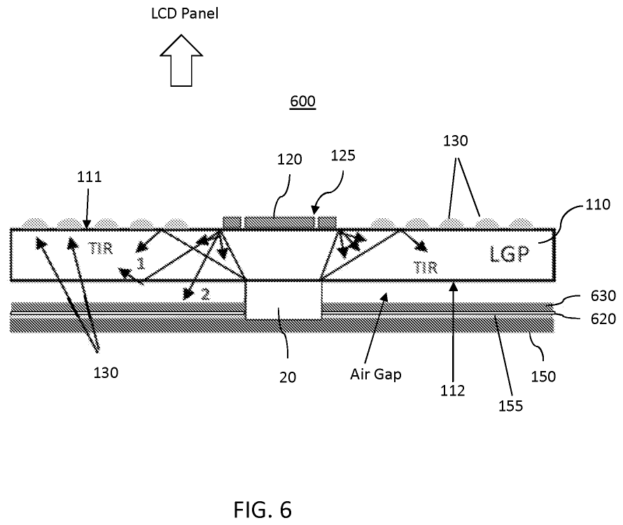

FIG. 6 shows an illustration of an architecture of a direct lit BLU 600 according to an embodiment of the present disclosure in which QDs are incorporated on the PCB that functionally supports the blue LED light source 20. The BLU 600 comprises a LGP 110 comprising a first major surface 111 facing in the direction of the LCD panel and a second major surface 112 opposite the first major surface 111. A light source 20 is provided over the second major surface 112 and is optically bonded to the second major surface 112. The light source 20 emits blue light. A plurality of light extraction features 130 are formed over the first major surface 111 of the LGP. A top reflector layer 120 is formed over the first major surface 111, positioned opposite from the light source 20.

A PCB 150 that functionally supports the LED light source 20 is attached to the LED light source from the side of the LED opposite from the light emitting side which is optically bonded to the LGP 110. The PCB 150 comprises a first surface facing the LGP 110, and the LED light source 20 is attached to the first surface of the PCB 150. Therefore, the LED 20 is optically bonded to the LGP on the light emitting side and is physically attached to and functionally supported by the PCB on the opposite side. The PCB 150 functionally supports the LED light source 20 because the PCB supplies the electricity for the LED light source.

The BLU 600 also comprises a back-reflection layer 155 formed over the first surface of the PCB 150. A QD material layer 620 is formed over the back-reflection layer 155. A barrier layer 630 is formed over the QD material layer 620. As can be seen, in contrast to some conventional BLU structures, a bottom barrier layer is not needed. An air gap is formed between the LGP 110 and the barrier layer 630. The QD material layer 620 comprises a plurality of red QDs and a plurality of green QDs. The red and green QDs are present in the QD material layer 620 in the ratio described above in connection with the other BLU embodiments.

One of the benefits of this embodiment of the BLU is that the QDs are operated in reflection, which means that the light rays will pass through the QD material layer 630 twice on each reflection off the back-reflection layer 155, thus increasing the wavelength conversion efficiency of the QDs.

In some embodiments of the BLU 600, the top reflector layer 120 is formed over the first major surface 111 of the LGP 110 in areas not occupied by the plurality of light extraction features 130. The top reflector layer 120 can comprise a patterned reflector with holes.

In some embodiments of the BLU 600, the QD material layer 620 comprises a red QD layer and a green QD layer formed as separate layers.

In all of the embodiments of the BLU shown in FIGS. 3 through 6, significant additional advantages can be realized if the red and green QD materials can be provided in separately printable ink form so that the QD layer can be fabricated by printing. First, the relative proportion of green and red QDs at any given point over the LGP and backlight area can be varied during the printing process, thus, improving the color uniformity. Secondly, red QD layer could be printed above the green QD layer, or vice versa, depending on the other specifics of the backlight design, for example, a presence of a blue reflector (a long pass filter). Since the green light can be absorbed and converted into red by red QDs, this could provide further boost to the conversion efficiency.

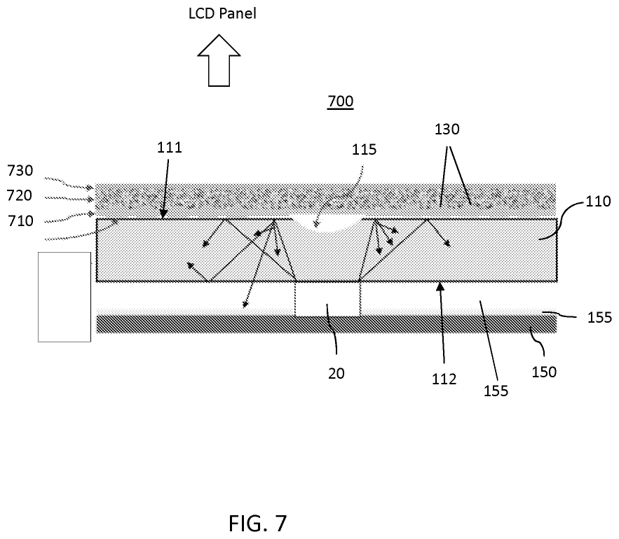

FIG. 7 shows an illustration of an architecture of a direct lit BLU 700 according to an embodiment of the present disclosure in which QDs are incorporated on the top surface of the LGP and the LGP includes a patterned reflective surface feature. The BLU 700 comprises a LGP 110 comprising two major surfaces, a first major surface 111 facing in the direction of the LCD panel and a second major surface 112 opposite the first major surface 111. The LGP 110 comprises a patterned surface reflection feature 115 formed over the first major surface 111 and positioned opposite from the light source 20. The patterned surface reflection feature 115 reflects and disperses the light rays emitting from the light source 20 into the LGP 110. The light source 20 is provided over the second major surface 112 of the LGP 110 and is optically bonded to the second major surface 112. The light source 20 emits blue light. A layer of low index material 710 is formed over the first major surface 111 of the LGP 110. A QD material layer 720 is formed over the layer of low index material 710. A barrier layer 730 is formed over the QD material layer 720. The QD material layer 720 comprises a plurality of red QDs and a plurality of green QDs. The red and green QDs are present in the ratios described above in connection with other BLU embodiments.

In some embodiments, the patterned surface reflection feature 115 comprises a concave curved reflecting surface as shown in FIG. 7. The concave curved reflecting surface curves downward from the first major surface 111 of the LGP toward the light source 20 and reflects and disperses the light rays emitting from the light source 20 into the LGP 110.

The BLU 700 further comprises a plurality of light extraction features 130 formed over the first major surface 111 of the LGP 110 between the QD material layer 720 and the low index material layer 710.

In some embodiments, the QD material layer 720 comprises a red QD layer and a green QD layer formed as separate layers.

In some embodiments of the BLU 700, a PCB 150 that functionally supports the LED light source 20 is attached to the LED light source from the side of the LED opposite from the light emitting side which is optically bonded to the LGP 110. The PCB 150 comprises a first surface facing the LGP 110, and the LED light source 20 is attached to the first surface of the PCB 150. Therefore, the LED 20 is optically bonded to the LGP on the light emitting side and is physically attached to and functionally supported by the PCB on the opposite side. The PCB 150 functionally supports the LED light source 20 because the PCB supplies the electricity for the LED light source. The PCB 150 also comprises a back-reflection layer 155 formed over its first surface.

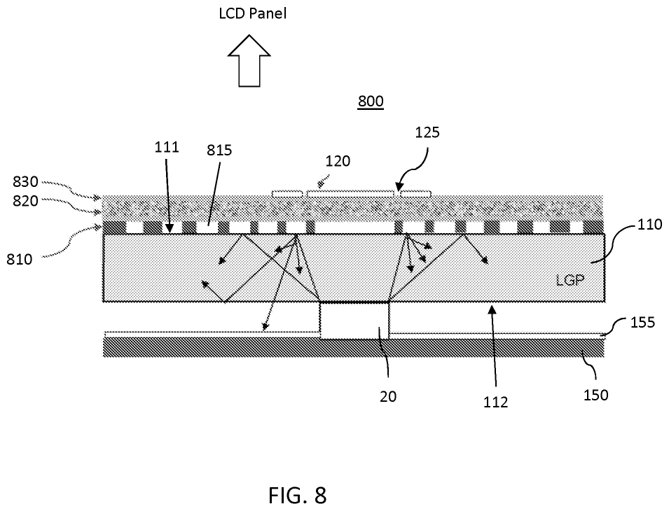

FIG. 8 shows an illustration of an architecture of a direct lit BLU 800 according to an embodiment of the present disclosure in which QDs are incorporated on the top surface of the LGP and also includes a patterned optical clear adhesive layer between the LGP and the QD material layer.

The BLU 800 comprises a LGP 110 comprising two major surfaces, a first major surface 111 facing in the direction of the LCD panel and a second major surface 112 opposite the first major surface 111. A light source 20 is provided over the second major surface 112 of the LGP and is optically bonded to the second major surface 112 of the LGP. The light source 20 emits blue light.

The BLU 800 also comprises a patterned optical clear adhesion (OCA) layer 810 for uniform light extraction formed over the first major surface 111 of the LGP 110. A QD material layer 820 with barrier layers 830 on both sides is optically bonded to the first major surface 111 of the LGP 110 by the patterned optical clear adhesion layer 810. A top reflector layer 120 is formed over the barrier layer 830, positioned opposite from the light source 20. The QD material layer 820 comprises a plurality of red QDs and a plurality of green QDs for light conversion. The red and green QDs are present in the ratios described above.

In some embodiments of the BLU 800, the patterned optical clear adhesion layer 810 comprises a plurality of openings 815 that form air gaps between the LGP 110 and the QD material layer 820. Because air has low refractive index, this configuration eliminates the need for an extraneous low index layer.

In some embodiments, the top reflector layer 120 comprises a patterned reflector with holes. In some embodiments, the QD material layer 820 comprises a red QD layer and a green QD layer formed as separate layers.

In some embodiments of the BLU 800, a PCB 150 that functionally supports the LED light source 20 is attached to the LED light source from the side of the LED opposite from the light emitting side which is optically bonded to the LGP 110. The PCB 150 comprises a first surface facing the LGP 110, and the LED light source 20 is attached to the first surface of the PCB 150. Therefore, the LED 20 is optically bonded to the LGP on the light emitting side and is physically attached to and functionally supported by the PCB on the opposite side. The PCB 150 functionally supports the LED light source 20 because the PCB supplies the electricity for the LED light source. The PCB 150 also comprises a back-reflection layer 155 formed over its first surface.

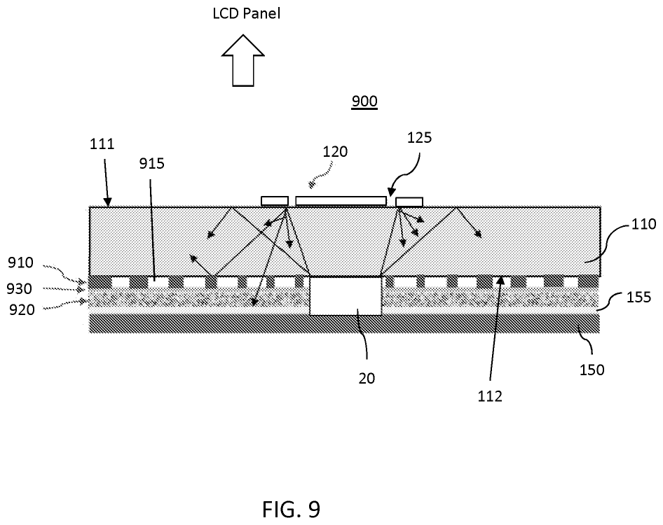

FIG. 9 shows an illustration of an architecture of a direct lit BLU 900 according to an embodiment of the present disclosure in which QDs are incorporated on the bottom surface of the LGP and also includes a patterned optical clear adhesive layer between the LGP and the QD material layer. The BLU 900 comprises a LGP 110 comprising two major surfaces, a first major surface 111 facing in the direction of the LCD panel and a second major surface 112 opposite the first major surface 111. A light source 20 is provided over the second major surface 112 of the LGP 110 and is optically bonded to the second major surface of the LGP. The light source 20 emits blue light.

The BLU 900 also comprises a patterned optical clear adhesion (OCA) layer 910 for uniform light extraction formed over the second major surface 112 of the LGP. A QD material layer 920 with a barrier layer 910 is formed between the patterned OCA layer 910 and the back-reflection layer 155 and occupy the space between the patterned OCA layer 910 and the back-reflection layer 155. A top reflector layer 120 is formed over the first major surface of the LGP 110, positioned opposite from the light source 20. The QD material layer 920 comprises a plurality of red QDs and a plurality of green QDs. The green and red QDs are present in ratios described above in connection with other BLU embodiments.

The patterned OCA layer 910 comprises a plurality of openings 915 that form air gaps between the LGP 110 and the QD material layer 920 and functions as a low index layer.

In some embodiments, the top reflector layer 120 comprises a patterned reflector with holes. The QD material layer 920 comprises a red QD layer and a green QD layer formed as separate layers.

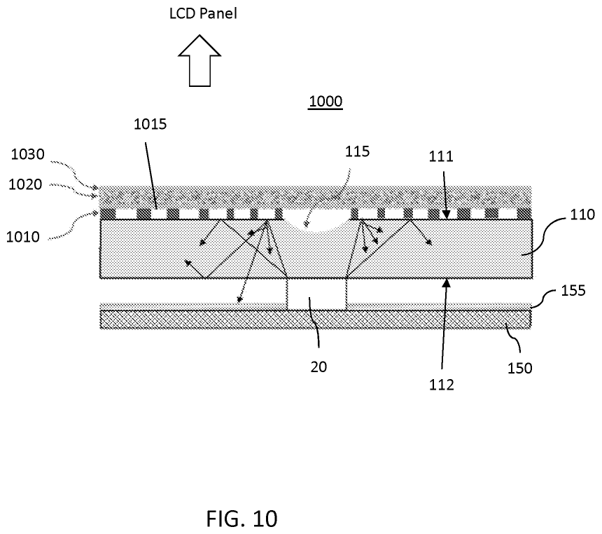

FIG. 10 shows an illustration of an architecture of a direct lit BLU 1000 according to an embodiment of the present disclosure in which QDs are incorporated on the top surface of the LGP that includes a patterned reflective surface feature and also includes a patterned optical clear adhesive layer between the LGP and the QD material layer.

The BLU 1000 comprises a LGP 110 comprising two major surfaces, a first major surface 111 facing in the direction of the LCD panel and a second major surface 112 opposite the first major surface 111. The LGP 110 comprises a patterned surface reflection feature 115 formed over the first major surface 111 and positioned opposite from the light source 20. The patterned surface reflection feature 115 reflects and disperses the light rays emitting from the light source 20 into the LGP 110.

The light source 20 is provided over the second major surface 112 of the LGP and is optically bonded to the second major surface 112 of the LGP. The light source 20 emits blue light.

The BLU 1000 also comprises a patterned OCA layer 1010 for uniform light extraction formed over the first major surface 111 of the LGP 110. A QD material layer 1020 with barrier layers 1030 on both sides is optically bonded to the first major surface 1015 of the LGP 110 by the patterned OCA layer 1010. A top reflector layer 120 is formed over the barrier layer 1030, and is positioned opposite from the light source 20. The QD material layer comprises a plurality of red QDs and a plurality of green QDs. The green and red QDs are present in the ratios described above in connection with other BLU embodiments.

The patterned surface reflection feature 115 comprises a concave curved reflecting surface that curves downward from the first major surface 111 of the LGP toward the light source 20 and reflects and disperses the light rays emitting from the light source 20 into the LGP 110.

In some embodiments, the patterned OCA layer 1010 comprises a plurality of openings 1015 that form air gaps between the LGP 110 and the QD material layer 1020.

The top reflector layer 120 can comprise a patterned reflector with holes. The QD material layer 1020 comprises a red QD layer and a green QD layer formed as separate layers.

In some embodiments of the BLU 1000, a PCB 150 that functionally supports the LED light source 20 is attached to the LED light source from the side of the LED opposite from the light emitting side which is optically bonded to the LGP 110. The PCB 150 comprises a first surface facing the LGP 110, and the LED light source 20 is attached to the first surface of the PCB 150. Therefore, the LED 20 is optically bonded to the LGP on the light emitting side and is physically attached to and functionally supported by the PCB on the opposite side. The PCB 150 functionally supports the LED light source 20 because the PCB supplies the electricity for the LED light source. The PCB 150 also comprises a back-reflection layer 155 formed over its first surface.

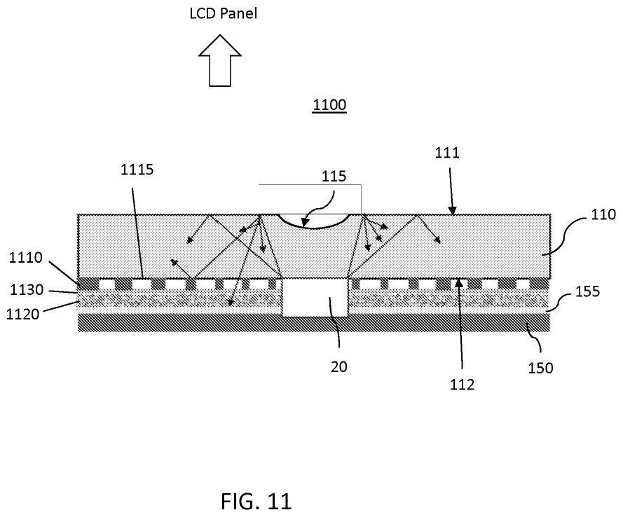

FIG. 11 shows an illustration of an architecture of a direct lit BLU 1100 according to an embodiment of the present disclosure in which QDs are incorporated on the bottom surface of the LGP that includes a patterned reflective surface feature and also includes a patterned optical clear adhesive layer between the LGP and the QD material layer.

The BLU 1100 comprises a LGP comprising two major surfaces, a first major surface 111 facing in the direction of the LCD panel and a second major surface 112 opposite the first major surface 111. The LGP 110 comprises a patterned surface reflection feature 115 formed over the first major surface 111 and positioned opposite from the light source 20. The patterned surface reflection feature 115 reflects and disperses the light rays emitting from the light source 20 into the LGP 110.

The light source 20 is provided over the second major surface 112 of the LGP and is optically bonded to the second major surface 112 of the LGP.

A patterned OCA layer 1110 for uniform light extraction is formed over the second major surface 112 of the LGP 110. A QD material layer 1120 with a barrier layer 1130 is formed between the patterned OCA layer 1110 and the back-reflection layer 155 and occupy the space between the patterned OCA layer 1110 and the back-reflection layer 155.

The top reflector layer 120 is formed over the first major surface 111 of the LGP, and is positioned opposite from the light source 20. The QD material layer 1120 comprises a plurality of red QDs and a plurality of green QDs. The red and green QDs are present in the ratios discussed above in connection with other BLU embodiments.

The patterned surface reflection feature 115 comprises a concave curved reflecting surface that curves downward from the first major surface 111 of the LGP toward the light source 20 and reflects and disperses the light rays emitting from the light source 20 into the LGP.

The patterned OCA layer 1110 comprises a plurality of openings 1115 that form air gaps between the LGP 110 and the QD material layer 1120.

The top reflector layer 120 comprises a patterned reflector with holes. The QD material layer 1120 comprises a red QD layer and a green QD layer formed as separate layers.

In some embodiments of the BLU 1100, a PCB 150 that functionally supports the LED light source 20 is attached to the LED light source from the side of the LED opposite from the light emitting side which is optically bonded to the LGP 110. The PCB 150 comprises a first surface facing the LGP 110, and the LED light source 20 is attached to the first surface of the PCB 150. Therefore, the LED 20 is optically bonded to the LGP on the light emitting side and is physically attached to and functionally supported by the PCB on the opposite side. The PCB 150 functionally supports the LED light source 20 because the PCB supplies the electricity for the LED light source. The PCB 150 also comprises a back-reflection layer 155 formed over its first surface.

According to some other embodiments, the red and green QDs can be placed between the blue LED light source 20 and the LGP 110. In some embodiments, the QD material can be incorporated into the structure of the blue LED light source 20 itself. In some embodiments, the QD material can be incorporated into the optical bonding material 25 for bonding the light source 20 to the LGP. In such embodiments, part of the blue light from the LED light source 20 is immediately converted to red and green light so that white light enters the LGP and no further downstream light conversion may be necessary. In other embodiments, yellow phosphor material can be utilized in place of the red and green QDs. When a layer of red/green QD or yellow phosphor is added over the blue light source, even if it is not sufficient to convert the blue light source to a desired white light, it improves the color conversion when combined with QD layers at other locations, such as in a top reflector.

[Emissive Displays]

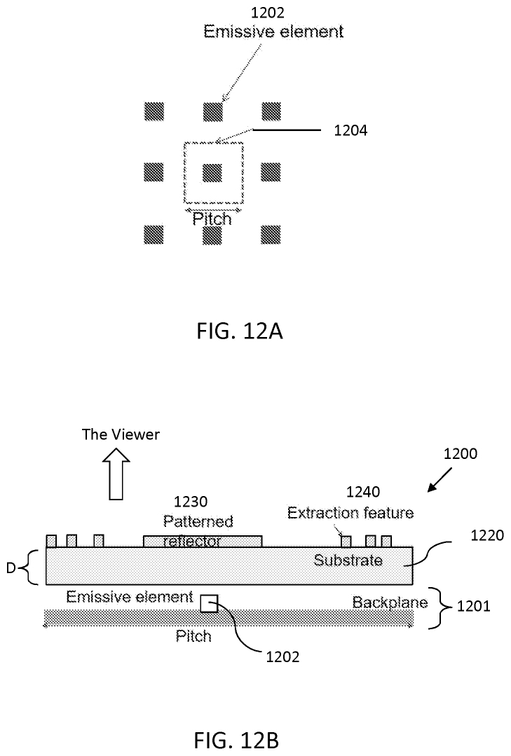

Referring to FIGS. 12A and 12B, according to another aspect of the present disclosure, an emissive display 1200 with a substrate having a patterned reflector is disclosed. Such emissive display includes a plurality of pixels that form an image on the display. Each pixel includes at least one emissive element, each emissive element being an LED. The emissive displays can be micro-LED displays, mini-LED display, LED display, OLED display, quantum-dot light emitting diodes (QD-LEDs), or other self-emissive displays.

FIG. 12 A is a schematic illustration of a portion of an emissive display showing an array of nine image pixels 1204 where each image pixel region comprises one emissive element 1202. A pitch of the emissive elements 1202 defines the equally-sized region around each of the emissive element 1202. The pitch is also the center-to-center distance between two closest neighboring emissive elements in the array of emissive elements.

In some applications of emissive displays, such as large outdoor signage displays that display very large images, a pixel is usually much larger than each individual emissive element (i.e., the LEDs). Although the pixels may look uniform from a distance, when viewed from a closer distance each pixel may have much brighter areas near the emissive elements.

Referring to FIG. 12B, to solve this problem, a transparent substrate 1220 having a patterned reflector 1230 is placed in front of the emissive display's backplane structure 1201 that comprises the emissive element 1202. FIG. 12B is a schematic sectional view of a region of the emissive display 1200 that is within one pitch of the emissive element 1202.

The transparent substrate 1220 can be made of any suitable material such as glass or plastic. The patterned reflector 1230 is aligned with the emissive element 1202 in the single-pitch region. The patterned reflector 1230 varies its reflectance and transmittance in space. In some embodiments, the patterned reflector 1230 is configured to have lower transmittance and higher reflectance near the emissive element than away from the emissive element so that the light emission viewed by the viewer is more uniform throughout the pixel area. This is achieved by the patterns for the reflector. As described above, the patterned reflector 1230 can be coatings or printed surfaces with either variable thickness, or variable surface coverage. Variable surface coverage may indeed look like a continuous coated area with holes in the coating, but could also be a collection of isolated “dots” or “islands” of coating typical of for example inkjet printed patterns, or a combination of isolated dots and continuous areas with holes. The patterned reflector 1230 can be integrated into the substrate 1220 and does not need to be on the surface of the substrate 1220.

In addition, in some embodiments, the substrate can also have a plurality of discrete light extraction features 1240 with varying densities provided within the single-pitch region of each of the emissive elements 1202. In general, the density of the light extraction features 1240 is higher away from the emissive element 1202 than near the emissive element 1202. This allows more light to be extracted in the regions of the pixel that are further away from the emissive element 1202. The light extraction features 1240 are preferably sufficiently efficient to extract substantially all light from the emissive element 1202 within the single-pitch region so that the light does not bleed into the neighboring emissive element's region.

The patterned reflector 1230 and the light extraction features 1240 can be on the same surface or different surface of the transparent substrate 1220. The patterned reflector 1230 can include one or more layers, of same or different materials to change its reflectance/transmittance.

The thickness D of the substrate 1220 is preferred to be small to reduce cross-talk (i.e., light bleeding) issue. Cross-talk occurs when a portion of the light from one pixel is spread over the neighboring pixel. On one hand, the light spreading in the horizontal direction makes a single pixel appear more uniform. On the other hand, when the light is spread into the neighboring pixel, the static contrast of the display is reduced.

The ratio D/Pitch, where Pitch is the pitch of the image pixel, is preferred to be smaller than 0.5, more preferably smaller than 0.2, and most preferably smaller than 0.1.

Generally, the light diffusion into the transparent substrate 1220 is maximized if the emissive elements 1202 are optically bonded to the transparent substrate 1220. However, in this configuration of the emissive display, the emissive elements 1202 do not need to be bonded to the bottom surface of the transparent substrate 1220 because the light from each of the emissive elements 1202 only need to be spread over one pitch of the emissive element, uniformity of light over a large area is not necessary. Additionally, by not having the emissive elements 1202 bonded to the transparent substrate 1220, aligning the substrate 1220 over the array of emissive elements on the backplane 1201 during assembly of the emissive display 1200 can be made easier. When the emissive elements are not bonded to the bottom surface of the transparent substrate 1220, some amount of air gap will exist between the bottom surface of the transparent substrate and the emissive elements. Therefore, in some embodiments, it may be desired that some means of coupling the light from the emissive elements 1202 to the substrate 1220 is present. In some embodiments, light scattering features can be present at the bottom surface of the substrate 1220, or on the top surface of the substrate 1220. If the light scattering features are present on the top surface, they will be under the patterned reflector 1230. Such light scattering features could be roughness, coatings with diffuse reflection, or specific types of roughness such as micro-optic features like grooves or prisms, or diffraction gratings.

[Light Guide having Light Extractor and a Patterned Reflector]

Perforated microcellular polyethylene terephthalate (MC-PET) is ideal as a patterned reflector. However, it suffers from a large coefficient of thermal expansion (CTE) of between about 5.0×10⁻⁵/° C. and 5.5×10⁻⁵/° C. This large CTE causes a large misalignment between the LED light sources in the direct-lit BLU architectures such as those shown in FIGS. 1, 2, 4, 5, 6, 8, and 9.

Perforated MC-PET needs to register the center of the low transmission area to every light source in the BLU at every temperature. For a large display of 65′ diagonal with horizontal dimension of about 1440 mm, for every 20 degrees C. change in temperature during operation, the perforated MC-PET can expand more than 3.8 mm, making misalignment between the LED light sources (smaller than 2 mm) and the perforated MC-PET unacceptable. Additionally, the misalignment can lead to buckling of the MC-PET due to thermal induced mechanical stress.

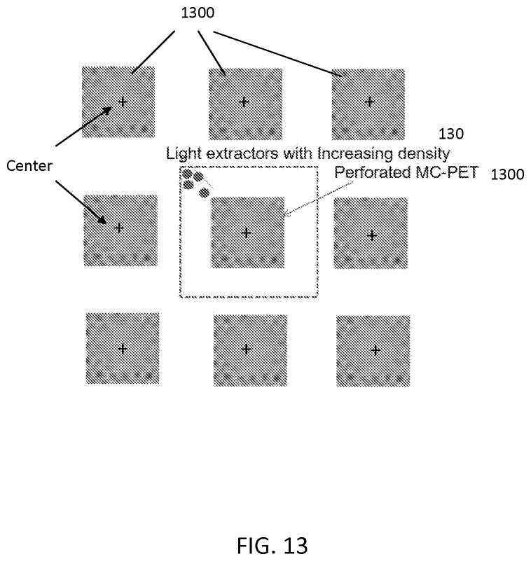

Referring to FIG. 13, in some embodiments of the present disclosure, bonding a plurality of segmented perforated MC-PET film 1300 on the LGP, where each MC-PET segment 1300 is registered with an LED. FIG. 13 is a top view illustration of the segmented perforated MC-PET film 1300. The Center of each MC-PET segment is aligned to an LED light source below the LGP. In the illustrated example, each of the MC-PET segment 1300 is about 10 mm to 100 mm on each side. Commonly used glass material used for LGPs has a CTE which is about 10 times smaller than the CTE of MC-PET, thus, the spacing between each of the segmented MC-PET regions 1300 does not change much with temperature fluctuation. In addition, even if each segment of MC-PET 1300 expands, it expands only over its small segment. The shape of each segmented perforated MC-PET can be any desired shape and can be circles, ellipses, squares, rectangles, or other suitable shapes.

The segmented perforated MC-PET can be used as the patterned reflectors in the embodiments of the direct-lit BLU architectures such as those discussed in reference to FIGS. 1, 2, 4, 5, 6, 8, and 9 above. Thus, the area around each of the segmented MC-PET 1300 can include light extraction features 130 discussed above.

While preferred embodiments of the present disclosure have been described, it is to be understood that the embodiments described are illustrative only and that the scope of the invention is to be defined solely by the appended claims when accorded a full range of equivalence, many variations and modifications naturally occurring to those of skill in the art from a perusal hereof.

1-70. (canceled)

71. A backlight unit (BLU), the BLU comprising a direct lighting configuration and comprising:
a light guide plate (LGP) comprising two major surfaces, a first major surface facing in the direction of the LCD panel and a second major surface opposite the first major surface;
a light source provided over the second major surface of the LGP, wherein the light source emits blue light; and
a top reflector layer formed over the first major surface of the LGP, positioned opposite from the light source,
wherein the top reflector layer comprises a red quantum dot (QD) material and a green QD material.

72. The BLU of claim 71, further comprising a plurality of light extraction features formed over the first major surface of the LGP in areas not occupied by the top reflector layer, wherein the plurality of light extraction features comprises the red quantum dot (QD) material and the green QD material.

73. The BLU of claim 71, wherein the top reflector layer comprises a patterned reflector with holes.

74. The BLU of claim 71, wherein the red and green QDs are present in the top reflector layer in a (red QDs) : (green QDs) ratio in the range from 1:2 to 1:20.

75. A backlight unit (BLU), the BLU comprising a direct lighting configuration and comprising:
a light guide plate (LGP) comprising two major surfaces, a first major surface facing in the direction of the LCD panel and a second major surface opposite the first major surface;
a light source provided over the second major surface of the LGP, wherein the light source emits blue light;
a layer of low index material formed over the first major surface of the LGP;
a quantum dot (QD) material layer formed over the layer of low index material;
a barrier layer formed over the QD material layer; and
a top reflector layer formed over the barrier layer, positioned opposite from the light source,
wherein the QD material layer comprises a plurality of red QDs and a plurality of green QDs.

76. The BLU of claim 75, further comprising a plurality of light extraction features formed over the first major surface of the LGP between the QD material layer and the low index material layer.

77. The BLU of claim 75, further comprising a plurality of light extraction features formed over the second major surface of the LGP.

78. The BLU of claim 75, wherein the top reflector layer comprises a patterned reflector with holes.

79. The BLU of claim 75, wherein the red and green QDs are present in the QD material layer in a (red QDs) : (green QDs) ratio in the range from 1:2 to 1:20.

80. A backlight unit (BLU), the BLU comprising a direct lighting configuration and comprising:
a light guide plate (LGP) comprising two major surfaces, a first major surface facing in the direction of the LCD panel and a second major surface opposite the first major surface;
a light source provided over the second major surface of the LGP, wherein the light source emits blue light;
a top reflector layer formed over the first major surface of the LGP, positioned opposite from the light source;
a plurality of light extraction features formed over the first major surface of the LGP in areas not occupied by the top reflector layer;
a layer of low index material formed over the second major surface of the LGP;
a quantum dot (QD) material layer formed over the layer of low index material; and
a barrier layer formed over the QD material layer;
wherein the QD material layer comprises a plurality of red QDs and a plurality of green QDs.

81. The BLU of claim 80, wherein the top reflector layer comprises a patterned reflector with holes.

82. The BLU of claim 80, wherein the red and green QDs are present in the QD material layer in a (red QDs) : (green QDs) ratio in the range from 1:2 to 1:20.

83. A backlight unit (BLU), the BLU comprising a direct lighting configuration and comprising:
a light guide plate (LGP) comprising two major surfaces, a first major surface facing in the direction of the LCD panel and a second major surface opposite the first major surface;
a light source provided over the second major surface of the LGP, wherein the light source emits blue light;
a plurality of light extraction features formed over the first major surface of the LGP;
a top reflector layer formed over the first major surface of the LGP, positioned opposite from the light source,
a printed circuit board (PCB) functionally supporting the light source, the PCB comprising a first surface facing the second major surface of the LGP, wherein the light source is attached to the first surface of the PCB;
a back-reflection layer formed over the first surface of the PCB;
a quantum dot (QD) material layer formed over the back-reflection layer;
a barrier layer formed over the QD material layer; and
whereby an air gap exists between the LGP and the barrier layer;
wherein the QD material layer comprises a plurality of red QDs and a plurality of green QDs.

84. The BLU of claim 83, wherein the top reflector layer is formed over the first major surface of the LGP in areas not occupied by the plurality of light extraction features.

85. The BLU of claim 83, wherein the top reflector comprises a patterned reflector with holes.

86. The BLU of claim 83, wherein the red and green QDs are present in the QD material layer in a (red QDs) : (green QDs) ratio in the range from 1:2 to 1:20.

87. A backlight unit (BLU), the BLU comprising a direct lighting configuration and comprising:
a light guide plate (LGP) comprising two major surfaces, a first major surface facing in the direction of the LCD panel and a second major surface opposite the first major surface,
wherein the LGP comprises a patterned surface reflection feature formed over the first major surface and positioned opposite from the light source, wherein the patterned surface reflection feature reflects and disperses the light emitting from the light source into the LGP;
a light source provided over the second major surface of the LGP, wherein the light source emits blue light;
a layer of low index material formed over the first major surface of the LGP;
a quantum dot (QD) material layer formed over the layer of low index material;
a barrier layer formed over the QD material layer; and
wherein the QD material layer comprises a plurality of red QDs and a plurality of green QDs.

88. The BLU of claim 87, wherein the patterned surface reflection feature comprises a concave curved reflecting surface that curves downward from the first major surface of the LGP toward the light source and reflects and disperses the light emitting from the light source into the LGP.

89. The BLU of claim 87, further comprising a plurality of light extraction features formed over the first major surface of the LGP between the QD material layer and the low index material layer.

90. The BLU of claim 87, wherein the red and green QDs are present in the QD material layer in a (red QDs) : (green QDs) ratio in the range from 1:2 to 1:20.

91. A backlight unit (BLU), the BLU comprising a direct lighting configuration and comprising:
a light guide plate (LGP) comprising two major surfaces, a first major surface facing in the direction of the LCD panel and a second major surface opposite the first major surface;
a light source provided over the second major surface of the LGP, wherein the light source emits blue light;
a patterned optical clear adhesion layer for uniform light extraction formed over the first major surface of the LGP;
a quantum dot (QD) material layer formed over the patterned optical clear adhesion layer;
a barrier layer formed over the QD material layer; and
a top reflector layer formed over the barrier layer, positioned opposite from the light source,
wherein the QD material layer comprises a plurality of red QDs and a plurality of green QDs.

92. The BLU of claim 91, wherein the patterned optical clear adhesion layer comprises a plurality of openings that form air gaps between the LGP and the QD material layer.

93. The BLU of claim 91, wherein the top reflector layer comprises a patterned reflector with holes.

94. The BLU of claim 91, wherein the red and green QDs are present in the QD material layer in a (red QDs) : (green QDs) ratio in the range from 1:2 to 1:20.

95. The BLU of claim 91, further comprising a printed circuit board (PCB) functionally supporting the light source, the PCB comprising a first surface facing the second major surface of the LGP, wherein the light source is attached to the first surface of the PCB; and
a back-reflection layer formed over the first surface of the PCB.

96. A backlight unit (BLU), the BLU comprising a direct lighting configuration and comprising:
a light guide plate (LGP) comprising two major surfaces, a first major surface facing in the direction of the LCD panel and a second major surface opposite the first major surface;
a light source provided over the second major surface of the LGP, wherein the light source emits blue light;
a printed circuit board (PCB) functionally supporting the light source, the PCB comprising a first surface facing the second major surface of the LGP, wherein the light source is attached to the first surface of the PCB;
a back-reflection layer formed over the first surface of the PCB;
a patterned optical clear adhesion (OCA) layer for uniform light extraction formed over the second major surface of the LGP;
a quantum dot (QD) material layer formed between the patterned OCA layer and the back-reflection layer and occupying the space between the patterned OCA layer and the back-reflection layer; and
a top reflector layer formed over the first major surface of the LGP, positioned opposite from the light source,
wherein the QD material layer comprises a plurality of red QDs and a plurality of green QDs.

97. The BLU of claim 96, wherein the patterned OCA layer comprises a plurality of openings that form air gaps between the LGP and the QD material layer.

98. The BLU of claim 96, wherein the top reflector layer comprises a patterned reflector with holes.

99. The BLU of claim 96, wherein the red and green QDs are present in the QD material layer in a (red QDs) : (green QDs) ratio in the range from 1:2 to 1:20.
